(19) United States
(12) Patent Application Publication
(10) Pub. No.: US 2020/0217683 A1
(43) Pub. Date: Jul. 9, 2020

(54) ENHANCED VEHICLE ROUTE OPERATION

(71) Applicant: Ford Global Technologies, LLC, Dearborn, MI (US)

(72) Inventors: David A. HERMAN, Southfield, MI (US); Nicholas COLELLA, Grosse Ile, MI (US); Colleen CAUVET, Canton, MI (US); Andrea Bowes CHOWANIC, West Bloomfield, MI (US)

(21) Appl. No.: 16/631,195

(22) PCT Filed: Jul. 18, 2017
(86) PCT No.: PCT/US2017/042528

§ 371 Date: Jan. 15, 2020

(51) Int. Cl. G01C 21/34; G01C 21/36

(52) U.S. Cl. CPC G01C 21/3492; G01C 21/3446; G01C 21/3605; G01C 21/3476

(57) ABSTRACT

An item previously obtained along the route is identified. A location on the route associated with the item is identified. A message is sent to the location to obtain the item. A vehicle component is actuated to move the vehicle to the location. A prompt is sent to the user for options to add a second item or cancel an order.

### BACKGROUND

Vehicles can travel along predetermined routes. Sources of items can be located on or near the routes. When the vehicle travels one of the routes, a user in the vehicle can deviate from the route to one of the sources to obtain an item. However, deviating from a route to acquire an item can make travel inefficient and/or difficult.

### BRIEF DESCRIPTION OF THE DRAWINGS

FIG. 1 is a block diagram of an example system for obtaining an item when a vehicle is travelling along a route.

FIG. 2 is an example route traveled by the vehicle including example sources of items.

FIG. 3 illustrates an example process for obtaining the item.

FIG. 4 illustrates an example process for associating the item with the route.

### DETAILED DESCRIPTION

A system includes a computer programmed to determine that a vehicle is travelling along a stored route, identify an item previously obtained along the route, identify a location on the route associated with the item, send a message to the location to obtain the item, and actuate a vehicle component to move the vehicle to the location.

The computer can be further programmed to receive a queue time from a plurality of locations along the route and to identify the location with the smallest queue time.

The computer can be further programmed to, upon identifying the location, prompt user input to send the message to one of the identified location and a different location along the route.

The computer can be further programmed to prompt a user to associate a second item with the route. The computer can be further programmed to, upon determining that the vehicle is travelling along the route, send a message to the identified location to obtain the item and the second item.

The computer can be further programmed to determine a preparation time for the item and to send the message when a predicted time of arrival of the vehicle at the identified location is less than the preparation time.

The computer can be further programmed to associate the item with the route upon determining that a user has obtained the item greater than a threshold number of times.

The computer can be further programmed to, upon sending the message to the identified location to obtain the item, prompt user input to send a second message to cancel obtaining the item.

The computer can be further programmed to, upon sending the message to the identified location to obtain the item, prompt user input to send a second message to obtain a second item.

The computer can be further programmed to receive a second message from the identified location indicating that the item has been prepared.

A method includes determining that a vehicle is travelling along a stored route, identifying an item previously obtained along the route, identifying a location on the route associated with the item, sending a message to the location to obtain the item, and actuating a vehicle component to move the vehicle to the location.

The method can further include receiving a queue time from a plurality of locations along the route and to identify the location with the smallest queue time.

The method can further include, upon identifying the location, prompting user input to send the message to one of the identified location and a different location along the route.

The method can further include prompting a user to associate a second item with the route. The method can further include, upon determining that the vehicle is travelling along the route, sending a message to the identified location to obtain the item and the second item.

The method can further include determining a preparation time for the item and sending the message when a predicted time of arrival of the vehicle at the identified location is less than the preparation time.

The method can further include associating the item with the route upon determining that a user has obtained the item greater than a threshold number of times.

The method can further include, upon sending the message to the identified location to obtain the item, prompting user input to send a second message to cancel obtaining the item.

The method can further include, upon sending the message to the identified location to obtain the item, prompting user input to send a second message to obtain a second item.

The method can further include receiving a second message from the identified location indicating that the item has been prepared.

Further disclosed is a computing device programmed to execute any of the above method steps. Yet further disclosed is a vehicle comprising the computing device. Yet further disclosed is a computer program product, comprising a computer readable medium storing instructions executable by a computer processor, to execute any of the above method steps.

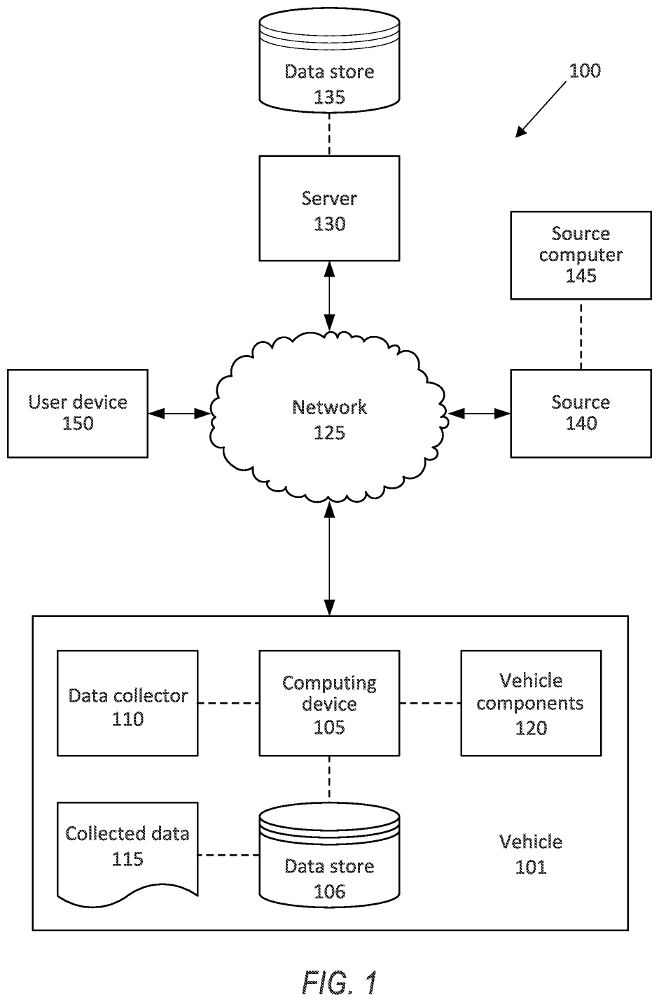

FIG. 1 illustrates an example system 100 for obtaining an item. A computer 105 in the vehicle 101 is programmed to receive collected data 115 from one or more sensors 110. For example, vehicle 101 data 115 may include a location of the vehicle 101, a location of a target, etc. Location data may be in a known form, e.g., geo-coordinates such as latitude and longitude coordinates obtained via a navigation system, as is known, that uses the Global Positioning System (GPS). Further examples of data 115 can include measurements of vehicle 101 systems and components, e.g., a vehicle 101 velocity, a vehicle 101 trajectory, etc.

The computer 105 is generally programmed for communications on a vehicle 101 network, e.g., including a communications bus, as is known. Via the network, bus, and/or other wired or wireless mechanisms (e.g., a wired or wireless local area network in the vehicle 101), the computer 105 may transmit messages to various devices in a vehicle 101 and/or receive messages from the various devices, e.g., controllers, actuators, sensors, etc., including sensors 110. Alternatively or additionally, in cases where the computer 105 actually comprises multiple devices, the vehicle network may be used for communications between devices represented as the computer 105 in this disclosure. In addition, the computer 105 may be programmed for communicating with the network 125, which, as described below, may include various wired and/or wireless networking technologies, e.g., cellular, Bluetooth®, Bluetooth® Low Energy (BLE), wired and/or wireless packet networks, etc.

The data store 106 may be of any known type, e.g., hard disk drives, solid state drives, servers, or any volatile or non-volatile media. The data store 106 may store the collected data 115 sent from the sensors 110.

Sensors 110 may include a variety of devices. For example, as is known, various controllers in a vehicle 101 may operate as sensors 110 to provide data 115 via the vehicle 101 network or bus, e.g., data 115 relating to vehicle speed, acceleration, position, subsystem and/or component status, etc. Further, other sensors 110 could include cameras, motion detectors, etc., i.e., sensors 110 to provide data 115 for evaluating a location of a target, projecting a path of a target, evaluating a location of a roadway lane, etc. The sensors 110 could also include short range radar, long range radar, LIDAR, and/or ultrasonic transducers.

Collected data 115 may include a variety of data collected in a vehicle 101. Examples of collected data 115 are provided above, and moreover, data 115 are generally collected using one or more sensors 110, and may additionally include data calculated therefrom in the computer 105, and/or at the server 130. In general, collected data 115 may include any data that may be gathered by the sensors 110 and/or computed from such data.

The vehicle 101 may include a plurality of vehicle components 120. As used herein, each vehicle component 120 includes one or more hardware components adapted to perform a mechanical function or operation—such as moving the vehicle, slowing or stopping the vehicle, steering the vehicle, etc. Non-limiting examples of components 120 include a propulsion component (that includes, e.g., an internal combustion engine and/or an electric motor, etc.), a transmission component, a steering component (e.g., that may include one or more of a steering wheel, a steering rack, etc.), a brake component, a park assist component, an adaptive cruise control component, an adaptive steering component, a movable seat, and the like.

When the computer 105 operates the vehicle 101, the vehicle 101 is an “autonomous” vehicle 101. For purposes of this disclosure, the term “autonomous vehicle” is used to refer to a vehicle 101 operating in a fully autonomous mode. A fully autonomous mode is defined as one in which each of vehicle 101 propulsion (typically via a powertrain including an electric motor and/or internal combustion engine), braking, and steering are controlled by the computer 105. A semi-autonomous mode is one in which at least one of vehicle 101 propulsion (typically via a powertrain including an electric motor and/or internal combustion engine), braking, and steering are controlled at least partly by the computer 105 as opposed to a human operator.

The system 100 may further include a network 125 connected to a server 130 and a data store 135. The computer 105 may further be programmed to communicate with one or more remote sites such as the server 130, via the network 125, such remote site possibly including a data store 135. The network 125 represents one or more mechanisms by which a vehicle computer 105 may communicate with a remote server 130. Accordingly, the network 125 may be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The system 100 includes a source 140 of items. The source 140 provides items that a user can obtain. The server 130 and/or the computer 105 can communicate with the source 140 over the network 125. The source 140 can be, e.g., a restaurant, a coffee shop, a hardware store, a department store, etc. The source 140 can include a source computer 145 including a processor and a memory. The source computer 145 can communicate with the server 130 and/or the computer 105 over the network 125. The source computer 145 can be any one of a variety of computing devices including, e.g., a personal computer, a smartphone, a tablet, a personal digital assistant, a cashier's terminal, etc.

The system 100 can include a user device 150. As used herein, a “user device” is a portable, computing device that includes a memory, a processor, a display, and one or more input mechanisms, such as a touchscreen, buttons, etc., as well as hardware and software for wireless communications such as described herein. Accordingly, the user device 150 may be any one of a variety of computing devices including a processor and a memory, e.g., a smartphone, a tablet, a personal digital assistant, etc. The user device 150 may use the network 125 to communicate with the vehicle computer 105. For example, the user device 150 and computer 105 can be communicatively coupled to each other with wireless technologies such as described above.

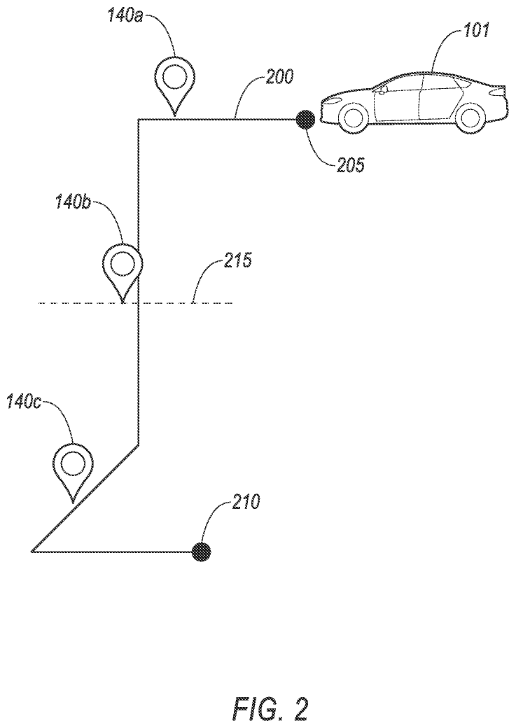

FIG. 2 illustrates an example route 200 that the vehicle 101 travels. The route 200 can be a stored route 200 (i.e., a set of geo-coordinates and instructions to actuate one or more vehicle components 120 to move the vehicle 101 along the route 200) and stored in the data store 106 and/or the server 130. The route 200 can be stored by, e.g., user input on a human-machine interface (HMI) in a vehicle 101 and/or a user device 150, a determination by the computer 105 that the vehicle 101 has traveled the route 200 more than a threshold number of times, etc. The route 200 can start at a start point 205 and end at an end point 210.

The route 200 can include locations for a plurality of sources 140. The computer 105 can receive the locations of the sources 140 from, e.g., the server 130. The computer 105 can communicate with the source computers 145 at the sources 140 over the network 125 to obtain items when the vehicle 101 is travelling along the route 200. Thus, the user in the vehicle 101 can purchase items when travelling along the route 200. FIG. 2 shows three example sources 140a, 140b, 140c accessible from the route 200. The locations of the sources 140a, 140b, 140c can be directly along the route 200 (e.g., adjacent to a roadway on which the route 200 lies) or near the route 200 (e.g., along a side street or cross street within a distance threshold of the route 200). As shown in FIG. 2, the locations of the sources 140a, 140c can be directly along the route 200, and are represented by location markers close to the route 200. The location of the source 140b can be along a side street 215 that is not on the route 200 but within a distance threshold of the route 200.

The computer 105 can identify that the vehicle 101 is on a stored route 200. For example, the user can provide input instructing the computer 105 to follow one of the stored routes. In another example, the computer 105 can, upon receiving user input indicating a start point 205 and an end point 210, determine that one of the stored routes 200 includes the received start point 205 and end point 210, and can follow the stored route 200. Upon determining that the vehicle 101 is on a stored route 200, the computer 105 can identify one or more items associated with the stored route 200. As described below, the user can purchase items when travelling along the route 200, e.g., food, beverages, fuel, etc. The computer 105 can be programmed to, upon determining that the user has obtained an item more than a threshold number of times when travelling along the route 200, associate the item with the stored route 200. When the computer 105 determines that the vehicle 101 is travelling along the route 200, the computer 105 can send a message to a source 140 to obtain the item associated with the route 200.

The computer 105 can select the source 140 to obtain the item. The route 200 can include a plurality of sources 140 to obtain the item, e.g., the sources 140a, 140b, 140c, as shown in FIG. 2. Each source 140 can include a source computer 145, as described above, that can communicate with the computer 105 over the network 125. The computer 105 can request a queue time for consumers and a preparation time for the item from each source 140. The source computer 145 can determine the queue time based on, e.g., crowd-sourced data, historical queue data, etc., and send the queue time over the network 125 to the computer 105. The source computer 145 can determine the preparation time for the item based on, e.g., historical preparation data, previously estimated preparation times, etc. The computer 105 can compare the queue times and the preparation times for each source 140 to a predicted time of arrival of the vehicle 101 at the location of each source 140. The computer 105 can select the source 140 that has a queue time and preparation time such that the predicted time to receive the item (after the preparation time) is closest to the queue time elapsed after the predicted time of arrival of the vehicle 101. That is, the computer 105 can select the source 140 such that the user can, upon arriving at the predicted time of arrival and waiting in a queue for the queue time, receive the item at or after the end of the preparation time. Alternatively or additionally, the computer 105 can select the source 140 with the smallest queue time. Furthermore, the computer 105 can be programmed to send the message to the source computer 145 of the selected source 140 to obtain the item when the predicted time of arrival is less than the preparation time. Upon selecting the source 140, the computer 105 can send a message over the network 125 to the source computer 145 of the selected source 140 with the order for the item. When the item is prepared, the source computer 145 can send a second message over the network 125 to the computer 105 and/or the user device 150 indicating that the item is prepared.

The computer 105 can be programmed to prompt the user to cancel obtaining the item. The computer 105 can send the message to the source 140 to obtain the item. The message can include a specified time to begin preparing the item based on the preparation time and the predicted time of arrival. The computer 105 can prompt the user, e.g., on the vehicle 101 HMI, the user device 150, etc., to cancel obtaining of the item prior to the specified time. The user can decide not to obtain the item and provide input to the computer 105 to cancel obtaining of the item. The computer 105 can send a second message over the network 125 to the source 140 to cancel preparation of the item. The computer 105 can be programmed to prompt the user to, upon canceling obtaining the item at the identified source 140, send a message to a different source 140 to obtain the item.

The computer 105 can prompt the user for input to purchase a second item. Upon determining that the vehicle 101 is travelling along the stored route 200, the computer 105 can send a message to one of the sources 140 to obtain a first item. The second item can be a complementary item to the first item, e.g., if the first item is coffee, the second item can be a pastry. The computer 105 can prompt the user on a vehicle 101 HMI and/or the user device 150. If the computer 105 receives user input to obtain the second item, the computer 105 can send a message to the source 140 to obtain the first item and the second item. Otherwise, the computer 105 can send the message to the source 140 to obtain only the first item. When the computer 105 determines that the user has requested the second item more than a threshold number of times, the computer 105 can associate the second item with the stored route 200 and, when the computer 105 next determines that the vehicle 101 is on the stored route 200, the computer 105 can send a message over the network 125 to the source 140 to obtain the item and the second item. Additionally, the computer 105 can prompt the user for input to purchase more than one item in addition to the first item, e.g., a third item, more than one of the second item, etc. The computer 105 can determine the additional items to prompt the user to purchase based on, e.g., historical data 115 stored in the server 130 of complementary items to the first item, a message from the source 140 of the first item suggesting additional items to purchase, etc.

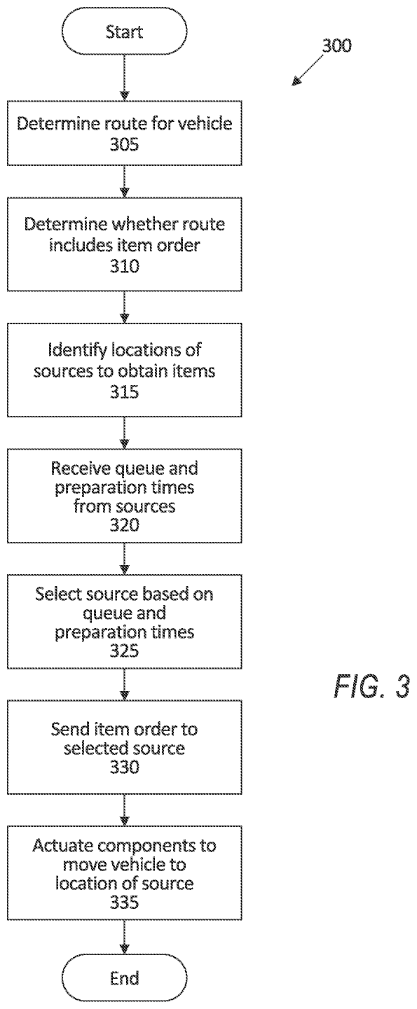

FIG. 3 illustrates an example process 300 for obtaining an item along a route 200. The process 300 begins in a block 305, in which the computer 105 determines that the vehicle 101 is on a stored route 200. As described above, the computer 105 can determine that the vehicle 101 is on a stored route 200 based on, e.g., user input selecting a stored route 200, geo-location data of a start point 205 and an end point 210 indicating a stored route 200, etc.

Next, in a block 310, the computer 105 determines whether the stored route 200 has one or more items associated with the route 200. The stored route 200 can include an order for a previously obtained item, e.g., food, beverages, etc. For example, if the user has purchased a beverage when travelling along the stored route 200 previously, the computer 105 can associate the beverage with the stored route 200. An example process 400 for associating an obtained item to a stored route 200 is described below.

Next, in a block 315, the computer 105 identifies locations of one or more sources 140 to obtain the items on the route 200. The computer 105 can identify locations from, e.g., the server 130. The server 130 can store geo-location coordinates for the sources 140, and the computer 105 can request the geo-location coordinates for each source 140 from the server 130. The computer 105 can identify locations of sources 140 from which the user previously obtained items along the route.

Next, in a block 320, the computer 105 receives queue times and preparation times for the items from each of the sources 140. As described above, each source computer 145 for each source 140 can send an estimated queue time and preparation time for the items to the server 130. The estimated queue time can be based on, e.g., historical queue time for the source 140. The preparation time can be based on, e.g., historical preparation time, a standardized preparation time, etc., for the source 140.

Next, in a block 325, the computer 105 selects a location of a source 140 based on the queue and preparation times. For example, the computer 105 can select the source 140 having a queue time and preparation time that is within a time threshold of a predicted time when the vehicle 101 will arrive at the location of the source 140 along the route 200. That is, the computer 105 can select the source 140 that would allow the user to obtain the item upon waiting for the duration of the queue time and at the end of the preparation time, reducing the amount of time between preparation of the item and obtaining the item by the user.

Next, in a block 330, the computer 105 sends a message to the source computer 145 of the source 140 to order the item. As described above, the computer 105 can send a message over the network 125 to the source computer 145, e.g., a text message to an item ordering system installed on the source computer 145, an electronic mail to a smartphone or tablet, a facsimile to a facsimile machine, etc.

Next, in a block 335, the computer 105 actuates one or more components 120 to move the vehicle 101 to the source 140. The computer 105 can actuate a propulsion 120 and a steering 120 to move the vehicle 101 along the route 200 to the location of the selected source 140 to obtain the item. Following the block 335, the process 300 ends.

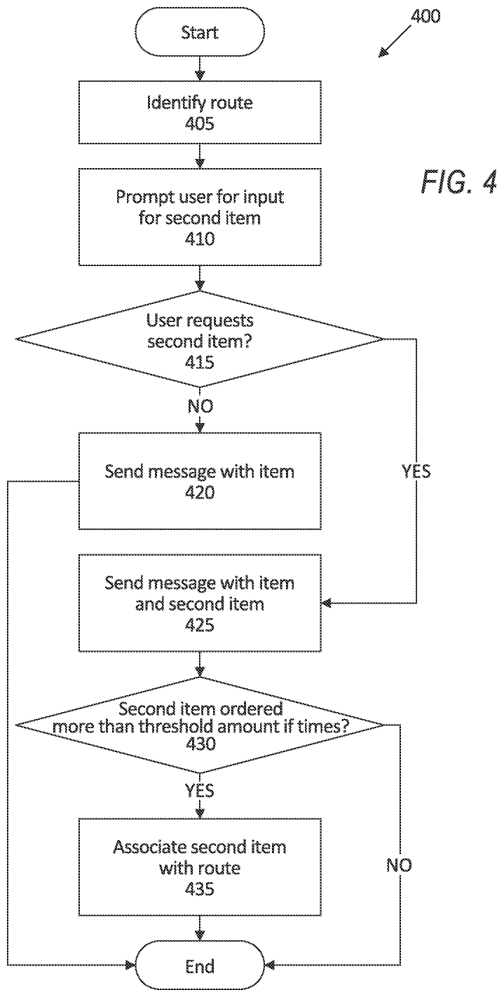

FIG. 4 illustrates an example process 400 for associating a second item with a stored route 200. The process 400 begins in a block 405, in which the computer 105 identifies the stored route. As described above, the computer 105 can identify the stored route 200 based on, e.g., user input, geo-location data 115, etc.

Next, in a block 410, the computer 105 prompts input for a second item to obtain on the route 200. The computer 105 is programmed to send a message to obtain a first item without input from the user, and the computer 105 can request input for additional items from the same source 140 as the first item. For example, if the first item is coffee, the computer 105 can prompt for user input to obtain a second item that is a pastry. The computer 105 can prompt input on, e.g., a vehicle 101 HMI, the user device 150, etc.

Next, in a block 415, the computer 105 determines whether the user has provided input to request the second item. The computer 105 can receive the input on, e.g., the vehicle 101 HMI, a user device 150, etc. If the computer 105 has received user input to obtain the second item, the process 400 continues in a block 425. Otherwise, the process 400 continues in a block 420.

In the block 420, the computer 105 sends the message to the source 140 to obtain the first item, as described above. The computer 105 can send the message to the source 140 over the network 125. Following the block 420, the process 400 ends.

In the block 425, the computer 105 sends a message to the source 140 to obtain the first item and the second item. The computer 105 can send the message to the source 140 over the network 125. The message can include specified times to begin preparation of the item and the second item based on the preparation times of the item and the second item and the predicted time of arrival at the source 140.

Next, in a block 430, the computer 105 determines whether the user has requested to obtain the second item more than a threshold number of times. When the user requests the second item more than the threshold number of times, the computer 105 can determine to obtain the second item on subsequent travelling of the stored route 200. If the second item has been ordered more than a threshold number of times, the process 400 continues in a block 435. Otherwise, the process 400 ends.

As used herein, the adverb “substantially” modifying an adjective means that a shape, structure, measurement, value, calculation, etc. may deviate from an exact described geometry, distance, measurement, value, calculation, etc., because of imperfections in materials, machining, manufacturing, data collector measurements, computations, processing time, communications time, etc.

Computers 105 generally each include instructions executable by one or more computers such as those identified above, and for carrying out blocks or steps of processes described above. Computer-executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media. A file in the computer 105 is generally a collection of data stored on a computer readable medium, such as a storage medium, a random access memory, etc.

A computer-readable medium includes any medium that participates in providing data (e.g., instructions), which may be read by a computer. Such a medium may take many forms, including, but not limited to, non-volatile media, volatile media, etc. Non-volatile media include, for example, optical or magnetic disks and other persistent memory. Volatile media include dynamic random access memory (DRAM), which typically constitutes a main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. For example, in the process 400, one or more of the steps could be omitted, or the steps could be executed in a different order than shown in FIG. 4. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a non-provisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

The article “a” modifying a noun should be understood as meaning one or more unless stated otherwise, or context requires otherwise. The phrase “based on” encompasses being partly or entirely based on.

What is claimed is:

1. A system, comprising a computer programmed to:
determine that a vehicle is travelling along a stored route;
identify an item previously obtained along the route;
identify a location on the route associated with the item;
send a message to the location to obtain the item; and
actuate a vehicle component to move the vehicle to the location.

2. The system of claim 1, wherein the computer is further programmed to receive a queue time from a plurality of locations along the route and to identify the location with the smallest queue time.

3. The system of claim 1, wherein the computer is further programmed to, upon identifying the location, prompt user input to send the message to one of the identified location and a different location along the route.

4. The system of claim 1, wherein the computer is further programmed to prompt a user to associate a second item with the route.

5. The system of claim 4, wherein the computer is further programmed to, upon determining that the vehicle is travelling along the route, send a message to the identified location to obtain the item and the second item.

6. The system of claim 1, wherein the computer is further programmed to determine a preparation time for the item and to send the message when a predicted time of arrival of the vehicle at the identified location is less than the preparation time.

7. The system of claim 1, wherein the computer is further programmed to associate the item with the route upon determining that a user has obtained the item greater than a threshold number of times.

8. The system of claim 1, wherein the computer is further programmed to, upon sending the message to the identified location to obtain the item, prompt user input to send a second message to cancel obtaining the item.

9. The system of claim 1, wherein the computer is further programmed to, upon sending the message to the identified location to obtain the item, prompt user input to send a second message to obtain a second item.

10. The system of claim 1, wherein the computer is further programmed to receive a second message from the identified location indicating that the item has been prepared.

11. A method, comprising:
determining that a vehicle is travelling along a stored route;
identifying an item previously obtained along the route;
identifying a location on the route associated with the item;
sending a message to the location to obtain the item; and
actuating a vehicle component to move the vehicle to the location.

12. The method of claim 11, further comprising receiving a queue time from a plurality of locations along the route and to identify the location with the smallest queue time.

13. The method of claim 11, further comprising, upon identifying the location, prompting user input to send the message to one of the identified location and a different location along the route.

14. The method of claim 11, further comprising prompting a user to associate a second item with the route.

15. The method of claim 14, further comprising, upon determining that the vehicle is travelling along the route, sending a message to the identified location to obtain the item and the second item.

16. The method of claim 11, further comprising determining a preparation time for the item and sending the message when a predicted time of arrival of the vehicle at the identified location is less than the preparation time.

17. The method of claim 11, further comprising associating the item with the route upon determining that a user has obtained the item greater than a threshold number of times.

18. The method of claim 11, further comprising, upon sending the message to the identified location to obtain the item, prompting user input to send a second message to cancel obtaining the item.

19. The method of claim 11, further comprising, upon sending the message to the identified location to obtain the item, prompting user input to send a second message to obtain a second item.

20. The method of claim 11, further comprising receiving a second message from the identified location indicating that the item has been prepared.
